(19) United States
(12) Patent Application Publication
(10) Pub. No.: US 2003/0127409 A1
(43) Pub. Date: Jul. 10, 2003

(54) Method and device for the safe command/control of the unfolding and folding of a tower crane

(75) Inventor: Jean-Paul Verchere, Saint Nizier Sous Charlieu (FR)

Correspondence Address: OLIFF & BERRIDGE, PLC, P.O. BOX 19928, ALEXANDRIA, VA, 22320, US

(73) Assignee: POTAIN, Ecully (FR)

(21) Appl. No.: 10/325,928

(22) Filed: Dec. 23, 2002

(30) Foreign Application Priority Data
Jan. 9, 2002 (FR) 02.00190

(51) Int. Cl. B66C 23/42

(52) U.S. Cl. 212/300

(57) ABSTRACT

In the case of a tower crane with folding mast and folding jib, the unfolding and folding movements being motorized by actuators such as rams, the invention allows automatic movement from a folded transport position to an unfolded work position or vice versa. When an unfolding or folding procedure has been selected by means of a switch and a command manipulator, the rams are actuated in turn, in a preestablished automatic sequence which corresponds to the selected procedure. The running of the sequence is controlled by means of a set of sensors which detect the arrival of mast and/or jib elements of the crane in intermediate positions and in the final position.

### BACKGROUND OF THE INVENTION

The present invention relates in general to the field of tower cranes with folding mast and folding jib. More particularly, the subject of this invention is a method and a device for the safe command/control of the unfolding and folding of such a tower crane to move from a folded transport position to an unfolded work position or vice versa or alternatively to move from a defined work position to another work position.

### DESCRIPTION OF THE PRIOR ART

A configuration of a tower crane with folding mast and folding jib is described, for example, in French patent FR 2682096 in the name of the Applicant. Mention may also be made of French patent FR 2796632 in the name of the Applicant, which more specifically describes a device for folding the front element of a crane jib, also known as the “jib tip”.

The tower cranes described in the aforementioned documents comprise, at their mast and at their jib, a certain number of articulations which are motorized by means of hydraulic rams associated with link and lever mechanisms known as linkages. The phases of unfolding and folding such cranes entail successive actuation of the various rams, in a well-defined order of succession, and with movement through intermediate positions which are also well defined.

The kinetics of the various phases in the unfolding and folding of such cranes is usually described in their user instructions, and the safety of each of these phases depends on the operator. The dangerous phases generally have positions identified by visual elements on the crane, or on diagrams in the user instructions. In the transport position, the crane is generally made safe by means of manual lockings, for example on the slewing device or on the lifting pulley block. The work position is generally made safe by a visual control or check.

As will be readily understood, manual and therefore human interventions still remain necessary and decisive in the phases of unfolding and folding of the crane. The result of this is that the command and control of these phases remain complex and entail the participation of highly specialized personnel, without safety being truly guaranteed, as there is nothing really preventing unanticipated or inappropriate maneuvers or sequences from being performed, and the risk of accident or injury to personal property or people cannot therefore be excluded.

### SUMMARY OF THE INVENTION

The present invention sets out to overcome these drawbacks and therefore to make the phases of unfolding and folding of a tower crane safe by eliminating the manual operations which might present risks, replacing them with automatic sequences.

To this end, the subject of the invention is essentially a method for the safe command/control of the unfolding and folding of a tower crane in which the unfolding and folding movements are motorized by actuators such as rams, the method consisting in selecting an unfolding or folding procedure defined by its initial position and its final position, in actuating the rams or other actuators in turn in a preestablished automatic sequence corresponding to the selected procedure, and in controlling the running of this sequence by detecting arrival of mast and/or jib elements of the crane in intermediate positions and in the final position.

The automatic sequence for unfolding and folding of the crane comprises, in particular, successive and/or alternate actuations of the rams or other actuators for the unfolding/folding of the mast and of the jib, each actuation of the ram or other actuator being interrupted by the detection of mast or jib elements arriving in a predetermined position, this detection then allowing the next ram or other actuator to be actuated.

In the case of a procedure for folding the crane to its folded transport position, the automatic folding sequence also comprises detection of mast and/or jib elements bearing against each other, or against elements of the chassis of the crane, and it may also comprise at least one action of locking in the folded transport position.

Another subject of the invention is a device for the safe command/control of the unfolding and folding of a tower crane for implementing the method described hereinabove. This device mainly comprises, in combination:

at least one switch for manual selection of an unfolding or folding procedure defined by its initial position and its final position,

a sequential command unit for commanding the rams or other actuators according to a selected procedure, and

a set of sensors designed to detect the arrival of mast and/or jib elements of the crane in intermediate and final positions, these sensors being connected to the sequential command unit commanding the rams or other actuators.

The device may comprise a manual switch having at least two positions for selecting an unfolding or folding configuration defined by its two extreme positions, and a command manipulator for selecting unfolding or folding, the combination of the actions on the switch and on the manipulator fully defining each unfolding or folding procedure.

The sequential command unit commanding the rams may consist of a set of relays commanding electrically operated valves of a hydraulic unit supplying the crane folding/unfolding rams, according to each sequence.

As for the set of sensors in the device, this advantageously comprises inductive position sensors fixed to mast element or to jib elements of the crane, or alternatively to a chassis element of this crane to control the arrival in the folded transport position.

The details of the automatic unfolding and folding sequences and the arrangement of the sensors which control these sequences, naturally depend upon the configuration of the crane, namely upon its overall layout and the way the mast and jib elements are unfolded/folded, and also upon the particular layout of the rams and associated linkages.

For example, in the case of a crane comprising a mast made as two elements articulated together, and a jib comprising a jib root, an intermediate jib element and a jib tip, articulated together, if appropriate with the insertion of a jib folding element, while there are provided a first ram for unfolding/folding the mast elements, a second ram for the overall unfolding/folding of the jib, and a third ram for unfolding/folding of the jib tip, these rams being associated with linkages, the invention anticipating that the automatic sequence of unfolding the crane comprises, in succession:

actuating the second ram to partially unfold the jib, the intermediate jib element making an acute angle with the jib root,

actuating the first ram to fully unfold the mast into an upright position,

actuating the second ram to continue to unfold the jib until the jib root is aligned with the intermediate jib element, and

actuating the third ram to align the jib tip with the intermediate element.

The procedures that can be selected using the switch may in particular comprise:

the move from the crane being in the fully folded transport position to the fully unfolded work position, the mast being upright and the jib aligned, and vice versa;

the move from a work position with the jib aligned, the mast upright, into a work position with shortened jib, the mast remaining upright, and vice versa.

In the particular example considered previously, this last procedure involves actuating only the second ram.

Thus, the method and the device which are the subjects of the invention allow the sequences for the full or partial unfolding and folding (depending on the procedure selected) to be run automatically, with the movements entailed by the unfolding and folding phases strung together automatically, the only manual intervention being the initial preselection of which procedure to perform, and the commanding thereof. The execution of the unfolding and folding operations is thus simplified and becomes performable, in complete safety, by non-specialist personnel, given that the unfolding and folding sequences are determined from the crane design phase, so as to avoid any risk of accident, it being impossible for any unanticipated maneuver or sequence to be performed. The elimination of manual operations additionally makes it possible to reduce the time needed to unfold or fold the crane. The inductive sensors used to control the positions and to allow the successive movements in the unfolding/folding sequences are particularly reliable and, in particular, insensitive to the weather, and this makes a further contribution to the safety of the running of the unfolding and folding phases. Finally, the method and the device which are the subjects of the invention not only ensure the safety of the unfolding and folding phases, but also provide the bearings-together and safety lockings needed for transporting the crane in the folded state.

### BRIEF DESCRIPTION OF THE DRAWINGS

The invention will be better understood with the aid of the description which follows, with reference to the appended schematic drawing which, by way of example, depicts one embodiment of this device for the safe command/control of the unfolding and folding of a tower crane:

FIG. 1 depicts, in the folded transport position, a tower crane equipped with the device which is the subject of the invention;

FIG. 2 depicts the same crane, in the unfolded work position;

FIGS. 3, 4 and 5 are diagrams illustrating intermediate positions of this crane in the process of being unfolded (or folded);

FIG. 6 shows another work position of the same crane;

FIG. 7 is a block diagram of the device for the command/control of the unfolding and folding of the crane in question;

FIGS. 8, 9, 10 and 11 are flow diagrams illustrating various unfolding and folding sequences obtained with this device.

### DESCRIPTION OF THE PREFERRED EMBODIMENT(S)

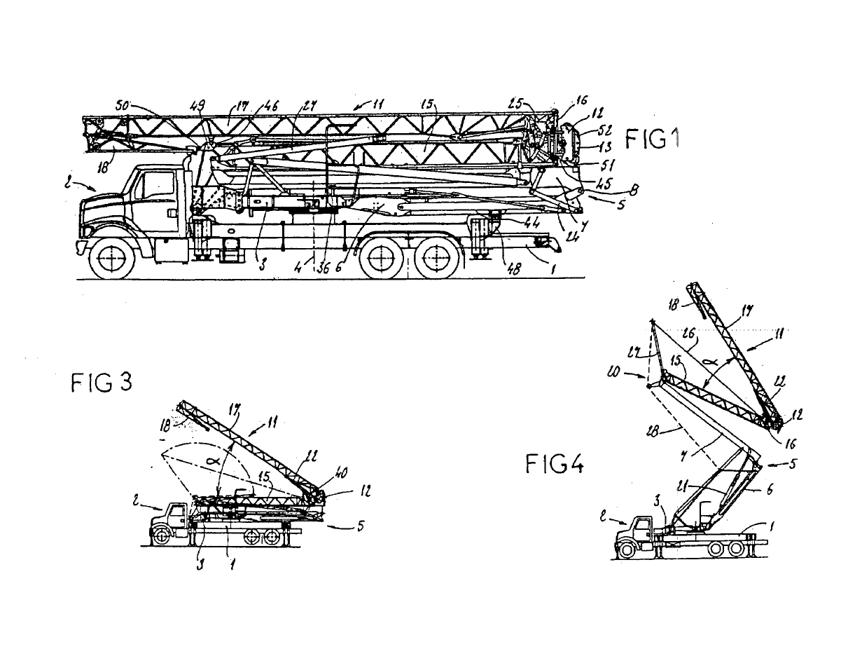

FIGS. 1 to 6 show a folding tower crane placed on the chassis 1 of a carrier vehicle 2 on which a rotary chassis 3 orientable about a vertical axis 4 is mounted. The crane comprises a mast 5 made of two elements 6 and 7 articulated together about a horizontal axis 8. The lower mast element 6 is articulated by its base, about a horizontal axis 9, to the front of the rotary chassis 3. Articulated about a horizontal axis 10 at the top of the upper mast element 7 is a delivery jib 11 along which a crab 12 can move, under which crab there is a lifting pulley block 13 to which a lifting hook 14 is attached. The jib 11 in this instance is made up of four successive elements, namely a jib root 15, a short jib-folding element 16, an intermediate jib element 17 and a jib tip 18. These jib elements 15, 16, 17 and 18 are articulated to one another about horizontal intermediate axes.

The crane also comprises stays 19 for erecting the mast 5 and a device 20 for retaining the jib 11, these being connected to the rear part of the rotary chassis 3.

Three double-acting hydraulic rams 21, 22 and 23 are provided for motorizing the unfolding and folding of the crane:

the first ram 21, situated at the lower mast element 6, is used to unfold/fold the mast elements 6 and 7. This ram 21 is associated with a linkage 24.

The second ram 22 is situated at the intermediate element 16 of the jib 11. Associated with a linkage 25 (see FIG. 1, to the right), this ram 22 is used to unfold/fold the first three elements 15, 16 and 17 of the jib 11.

The third ram 23 is situated at the articulation between the jib tip 18 and the front of the intermediate jib element 17. This last ram 23 is thus used for unfolding/folding the jib tip 18 with respect to the intermediate element 17.

Jib 11 retaining device 20 mentioned earlier here comprises a jib tie rod 26 connecting the front of the jib root 15 to the top of a post 27, articulated on the rear part of the jib 11, and a cable 28 directed downward, which goes from the top of the post 27 and is extended downward via a rigid elongate element 29 connected by its base to the rear part of the rotary chassis 3. In addition, a link 30 connects the point where the cable 28 and the rigid element 29 meet to the upper region of the lower mast element 6.

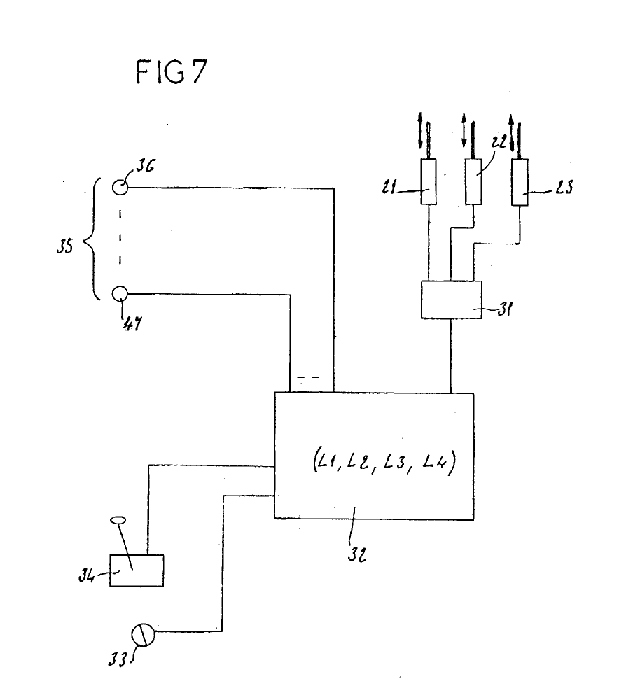

Referring also to FIG. 7, the device for commanding/controlling the unfolding and folding of the crane comprises a hydraulic unit 31 equipped with electrically operated valves, not depicted, for supplying pressurized hydraulic fluid to the three rams 21, 22 and 23. The electrically operated valves are driven from a sequential command unit 32 itself receiving its orders from a manual switch 33 and from a command manipulator 34, and signals from a set of sensors denoted overall by 35.

The manual switch 33 is a switch with N positions, including two particular positions denoted A and B which in this instance allow preselection between two, unfolding or folding, configurations:

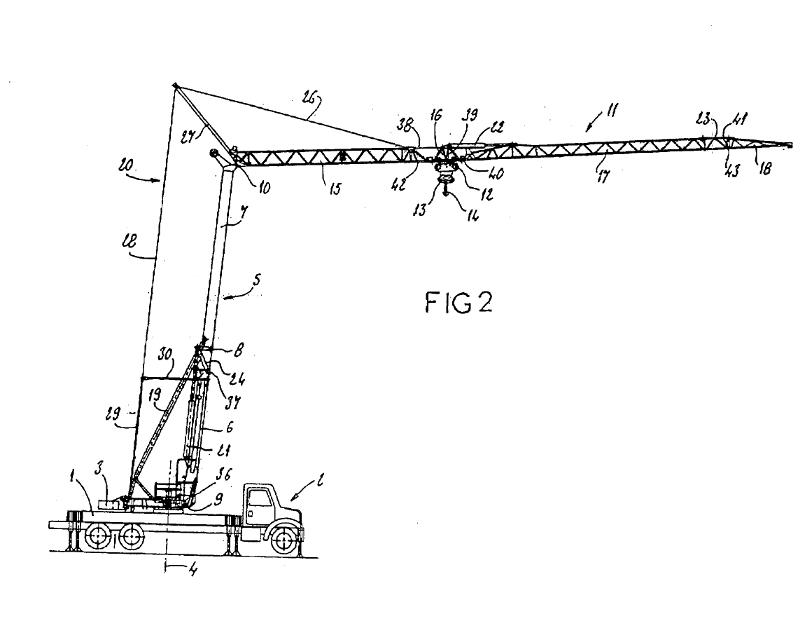

position A corresponds to the move from the fully folded crane (FIG. 1) to the fully unfolded crane with its mast 5 upright and its jib 11 aligned (FIG. 2) or vice versa;

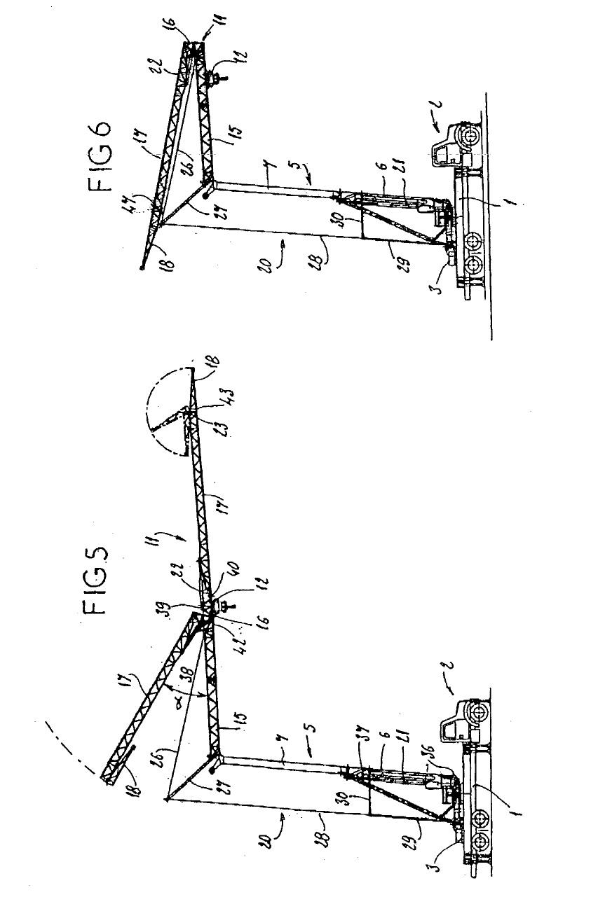

position B corresponds to the move from a fully unfolded crane with its mast 5 upright and its jib 11 aligned (FIG. 2) to a position in which the mast 5 is still upright when the jib 11 is folded (FIG. 6), or vice versa.

The command manipulator 34 is a manipulator with two positions, one for unfolding and one for folding, which positions, combined with the two positions A and B of the switch 33, allow four procedures or sequences denoted L1 to L4 respectively to be commanded:

L1 denotes the move from the fully folded crane (transport position) to the fully unfolded crane with its mast 5 upright and its jib 11 aligned, in other words the sequence for fully unfolding the crane, bringing this crane into its ordinary work position according to FIG. 2.

L2 denotes the reverse move from the fully unfolded crane with its mast 5 upright and its jib 11 aligned to the fully folded position, in other words the sequence of fully folding the crane, returning this crane to its transport position according to FIG. 1.

L3 denotes the move from the completely unfolded crane with its mast 5 upright and its jib 11 aligned to the position in which the mast 5 remains upright but the jib 11 is folded, in other words the sequence of partial folding bringing the crane into a particular work position with a shortened jib 11, according to FIG. 6.

L4 denotes the reverse move from the crane in a position with its mast 5 upright but the jib 11 folded, to the fully unfolded position, the mast 5 being upright and the jib 11 aligned, in other words the sequence of partial unfolding from the work position with shortened jib 11 to the ordinary work position.

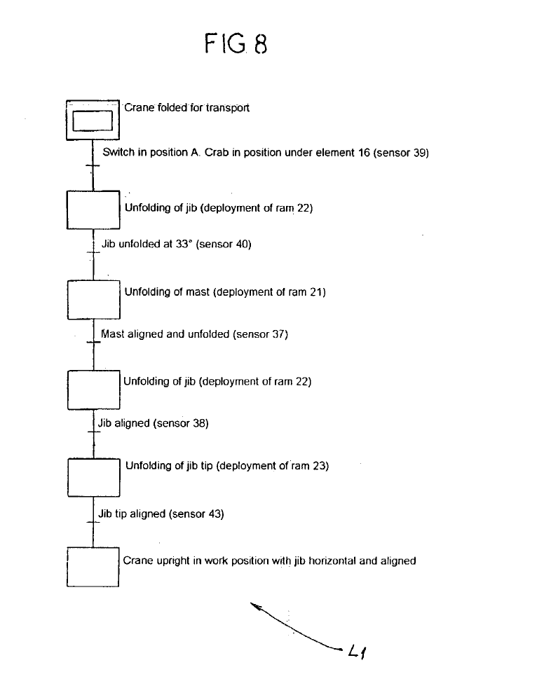

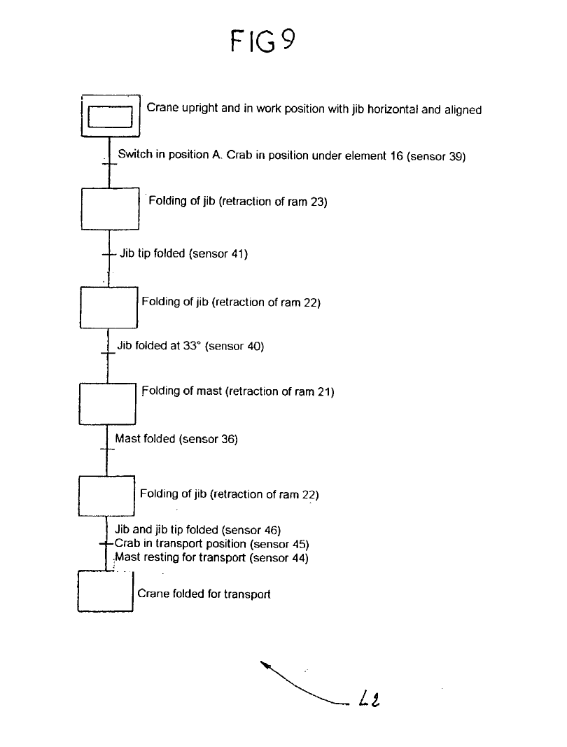

The sequential command unit 32 consists of a set of relays actuated according to the flow diagrams of FIGS. 8 to 11 to perform the various full or partial unfolding and folding sequences L1 to L4 defined hereinabove.

The set of sensors 35 comprises, in the particular example illustrated in the drawing:

an inductive first sensor 36 fixed on the rotary chassis 3 where the mast 5 rests, the sensor 36 being actuated by the upper mast element 7 in the folded position, to control the “mast folded” position;

an inductive second sensor 37 fixed to the base of the upper mast element 7, where it is articulated (axis 8) to the lower mast element 6, the sensor 37 being actuated by the lower mast element 6 in its position aligned with the upper mast element 7 to control the “mast unfolded” position;

an inductive third sensor 39 fixed on the front part of the jib root 15, at the linkage 25 and therefore at the articulation to the jib-folding element 16, the sensor 38 being actuated by this linkage 25 when the two rear elements 15 and 16 of the jib 11 are aligned, to control the “jib aligned” position;

an inductive fourth sensor 39 fixed to the folding element 16 of the jib 11, at the lower member of this element 16 and more or less centrally, the sensor 39 being actuated by the crab 12 when the latter is centerd on the lower member of the element 16, to control the “crab position for the folding the jib” situation;

an inductive fifth sensor 40 fixed on the rear part of the intermediate jib element 17, therefore at the articulation between this intermediate element 17 and the folding element 16, the sensor 40 being actuated when the angle α formed by the jib root 15 and the intermediate element 17 is equal to approximately 33°, to control the particular “jib at approximately 33° to open the post 27” position;

an inductive sixth sensor 41 fixed to the front part of the intermediate jib element 17, at the jib tip 18 articulation linkage, the sensor 41 being actuated by this linkage when the jib tip 18 is folded onto the intermediate jib element 17, to control the “jib tip folded” position;

an inductive seventh sensor 42, which is a roller sensor, fixed to the front part of the jib root 15, at the lower member of this jib element, the sensor 42 being actuated by a horizontal ramp fixed on the crab 12 when the latter is positioned at the front end of the jib root 15, to control the “crab position for shortened jib” situation;

an inductive eighth sensor 43 fixed to the front part of the intermediate jib element 17 and actuated by the jib tip 18 when these two elements 17 and 18 of the jib 11 are aligned, to control the “jib tip aligned” position;

an inductive ninth sensor 44 fixed to the chassis 1 of the carrier vehicle 2, here considered to be a “fixed” chassis (as opposed to the rotary chassis 3), the sensor 44 being actuated by the lower mast element 6 in the folded position, to control the “mast folded and resting for transport” position;

an inductive tenth sensor 45 fixed on the folding element 16 of the jib 11 at the lower member of this element 16 and more or less at its rear end, the sensor 45 being actuated by a vertical ramp fixed on the crab 12 when the latter is in the rear position on the lower member of the element 16, to control the “crab position for transport” situation;

an inductive eleventh sensor 46 fixed on the jib root 15 at the upper member of this jib element and at its rear end, the sensor 46 simultaneously controlling the resting of the intermediate jib element 17 on the jib root 15 and the resting of the jib tip 18 on the jib root 15, to control the “intermediate jib element folded and jib tip folded for transport” position; and

an inductive twelfth sensor 47 fixed on the intermediate jib element 17 at the upper member of this jib element 17, the sensor 47 being actuated by the jib tie rod 26, to control the “jib folded for work with shortened jib” position.

Finally, the crane has a certain number of resting bearings and safety locks, for transport (see FIG. 1):

a first bearing rest 48 is provided between the lower mast element 6 and the fixed chassis 1 (the chassis of the carrier vehicle 2). The rest 48, which is V-shaped, consists of a cradle articulated about a horizontal axis on lugs which are fixed in the rear part of the fixed chassis.

A second bearing rest 49, also V-shaped, is provided between the intermediate jib element 17 and the jib root 15.

A third bearing rest 50 is provided between the jib tip 18 and the jib root 15.

A fourth bearing rest 51 is provided between the crab 12 and the base of the upper mast element 7. The rest 51 consists of the body of a link articulated to the crab 12 and of a pad fixed to the mast element 7.

A locking 52 of the lifting pulley block 13 on the crab 12 is achieved by the same link, which for this purpose is fitted with a pad fixed at its end.

It will be noted that in a transport position (FIG. 1) the upper mast element 7 is folded against the lower mast element 6 while the jib 11 is folded up in a “curled up” configuration; the two mast elements 6 and 7, the jib root 15, the intermediate jib element 17 and the jib tip 18 are therefore parallel to the fixed chassis 1, and therefore roughly horizontal, while the folding element 16 of the jib 11 is arranged vertically, with the crab 12, at the rear of the carrier vehicle 2.

In the example illustrated in the drawing, the work positions (FIGS. 2 and 6) are configurations in which the jib 11, aligned or shortened, is more or less horizontal. A work configuration with the jib 11 raised, for example inclined by about 20° to the horizontal may, however, be chosen, before unfolding, by prior adjustment of the length of the jib tie rod 26.

By way of example, the sequence L1 of unfolding the crane with a move from the folded transport position (FIG. 1) to the fully unfolded work position (FIG. 2) is considered. This sequence L1 is performed moving through the intermediate positions illustrated in FIGS. 3, 4 and 5 and in accordance with the flow diagram of FIG. 8.

To start with, the operator places the switch 33 in position A and the manipulator 34 in the “unfold” position. The crab 12 is initially situated on the folding element 16 of the jib 11 and it will maintain this position throughout the unfolding sequence which comprises, in succession:

actuation of the second ram 22 in the direction of deployment, to unfold the jib 11 as far as the angle α of 33° (FIG. 3);

through action of the fifth sensor 40, stopping the previous movement and allowing the first ram 21 to be actuated;

actuating the first ram 21 in the direction of deployment, to unfold the mast 5 (FIG. 4);

by action of the second sensor 37, detecting the full unfolding of the mast 5 (FIG. 5) and allowing further actuation of the second ram 22;

actuating the second ram 22, still in the direction of deployment, until the three first jib elements 15, 16 and 17 are aligned;

by action of the third sensor 38, detecting that these jib elements 15, 16 and 17 are aligned, stopping the previous movement and allowing the third ram 23 to be actuated;

actuating the third ram 23 in the direction of deployment to unfold the jib tip 18;

by action of the eighth sensor 43, detection of the alignment of the jib tip 18 with the intermediate jib element 17, stopping the latter movement and allowing the crane to be put into use.

To fully fold the crane, the reverse sequence L2 is executed according to the flow diagram of FIG. 9. In addition, during this folding of the crane with a view to transporting it, the various bearing rests mentioned earlier act in the following order (at the end of folding);

the bearing rest 48 of the lower mast element 6 comes to bear on the fixed chassis 1;

the bearing rest 15 acts between the jib tip 18 and the jib root 15;

the bearing rest 49 acts between the intermediate jib element 17 and the jib root 15;

the bearing rest 51 acts between the crab 12 and the upper mast element 7;

the lifting pulley block 13 is locked at 52 on the crab 12.

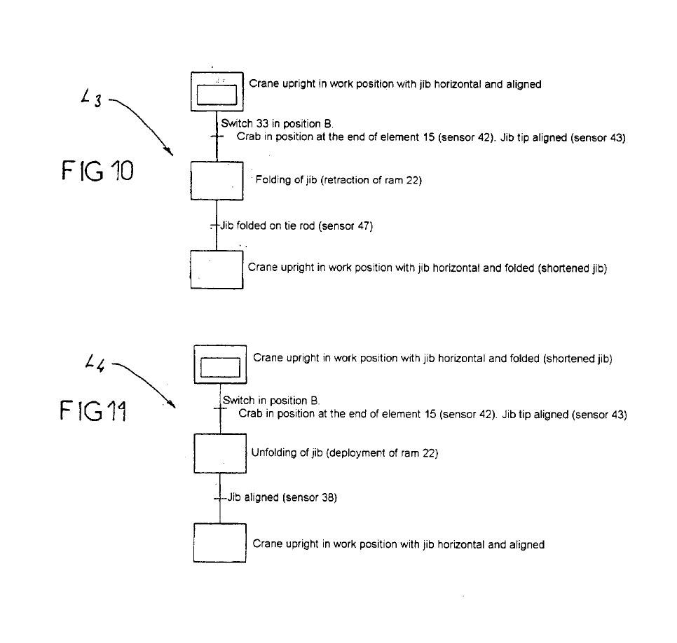

The flow diagrams of FIGS. 10 and 11 finally describe the sequences L3 and L4 for moving from the work position with the jib aligned (FIG. 2) to the work position with the shortened jib (FIG. 6) and vice versa. These sequences, which are simpler, involve only the second ram 22. It will be noted that, in order to execute the sequences L3 and L4, the crab 12 has to be situated on the jib root 15, which is working part of the shortened jib 11.

The various sequences described above can be commanded at a single speed, or with a choice between two or more speeds.

It would not be departing from the scope of the invention as defined in the appended claims:

if the sequential command unit with relays were replaced by a programmable controller;

if sensors of any type, such as push-rod-operated or roller-operated end-off-travel sensors were used;

if switches with more than two positions were provided;

if the invention were applied to cranes with different configurations with kinetics, for example with telescopic mast or with folding and telescopic mast or with telescopic jib (the ideas of “unfolding” and “folding” here encompass the idea of telescopic adjustment), or alternatively with a jib made up of a different number of elements, with these elements being folded in a “curled up” or “concertina” fashion;

if the unfolding and folding sequences were adapted to suit each particular crane configuration and kinetics;

if the number and arrangement of the sensors were also tailored to each particular crane configuration and kinetics;

if the invention were applied to cranes the unfolding and folding movements of which are fully or partially commanded by actuators other than rams, such as by cables and winches.

1. A method for the safe command/control of the unfolding and folding of a tower crane with folding mast and folding jib, to move from a folded transport position into an unfolded work position, or vice versa, or alternatively to move from a defined work position to another work position, the unfolding and folding movements being motorized by actuators such as rams, which method consists in selecting an unfolding or folding procedure defined by its initial position and its final position, in actuating the rams or other actuators in turn in a preestablished automatic sequence corresponding to the selected procedure, and in controlling the running of this sequence by detecting arrival of mast and/or jib elements of the crane in intermediate positions and in the final position.

2. The method as claimed in claim 1, wherein the automatic sequence for unfolding and folding of the crane comprises successive and/or alternate actuations of the rams or other actuators for the unfolding/folding of the mast and of the jib, each actuation of the ram or other actuator being interrupted by the detection of mast or jib elements arriving in a predetermined position, this detection then allowing the next ram or other actuator to be actuated.

3. The method as claimed in claim 1 or 2, wherein, in the case of a procedure for folding the crane to its folded transport position, the automatic folding sequence also comprises detection of mast and/or jib elements bearing against each other, or against elements of the chassis of the crane, and it may also comprise at least one action of locking in the folded transport position.

4. The method as claimed in any one of claims 1 to 3, wherein the procedures that can be selected comprise:
the move from the crane being in the fully folded transport position to the fully unfolded work position, the mast being upright and the jib aligned, and vice versa;
the move from a work position with the jib aligned, the mast upright, into a work position with shortened jib, the mast remaining upright, and vice versa.

5. The method as claimed in any one of claims 1 to 4, wherein, in the case of a crane comprising a mast made as two elements articulated together, and a jib comprising a jib root, an intermediate jib element and a jib tip, articulated together, if appropriate with the insertion of a jib folding element, while there are provided a first ram for unfolding/folding the mast elements, a second ram for the overall unfolding/folding of the jib, and a third ram for unfolding/folding of the jib tip, these rams being associated with linkages, the automatic sequence of unfolding the crane comprises, in succession:
actuating the second ram to partially unfold the jib, the intermediate jib element making an acute angle with the jib root,
actuating the first ram to fully unfold the mast into an upright position,
actuating the second ram to continue to unfold the jib until the jib root is aligned with the intermediate jib element, and
actuating the third ram to align the jib tip with the intermediate jib element.

6. The method as claimed in the combination of claims 4 and 5, wherein the automatic sequence removing the crane from the fully unfolded position with the jib aligned into the work position with the jib shortened involves actuating the second ram only.

7. A device for the safe command/control of the unfolding and folding of a tower crane with folding mast and folding jib, the unfolding and folding movements being motorized by rams or other actuators, which device comprises, in combination:
at least one switch for manual selection of an unfolding or folding procedure defined by its initial position and its final position,
a sequential command unit for commanding the rams or other actuators according to a selected procedure, and
a set of sensors designed to detect the arrival of mast and/or jib elements of the crane in intermediate and final positions, these sensors being connected to the sequential command unit commanding the rams or other actuators.

8. The device as claimed in claim 7 and which comprises a manual switch having at least two positions for selecting an unfolding or folding configuration defined by its two extreme positions, and a two-position command manipulator for selecting unfolding or folding, the combinations of the actions on the switch and on the manipulator fully defining each unfolding or folding procedure.

9. The device as claimed in claim 7 or 8, wherein the sequential command unit commanding the rams consists of a set of relays commanding electrically operated valves of a hydraulic unit supplying the crane folding/unfolding rams.

10. The device as claimed in any one of claims 7 to 9, wherein the set of sensors comprises inductive position sensors fixed to mast elements or to jib elements of the crane, or alternatively to a chassis element of this crane to control the arrival in the folded transport position.
